(19) United States
(12) Patent Application Publication
(10) Pub. No.: US 2005/0253692 A1
(43) Pub. Date: Nov. 17, 2005

(54) Baby in Car Alert

(75) Inventor: Nadine Marie Lukes-Dyer, Fullerton, CA (US)

Correspondence Address: NADINE M. LUKES-DYER, 2717 VIA PORTOLA, FULLERTON, CA, 92835, US

(73) Assignee: Nadine Marie Lukes-Dyer, Fullerton, CA (US)

(21) Appl. No.: 10/709,566

(22) Filed: May 13, 2004

(51) Int. Cl. B60R 25/10

(52) U.S. Cl. 340/429; 340/438

(57) ABSTRACT

A method of reminder via audio alert in which weight applied to a pressure sensitive switch arms but does not activate the sound device. The unit is plugged into the vehicle's pre-existing cigarette lighter socket which, when the ignition key is in the “accessory” or “on” position provides a 12 VDC flow of power into the unit. When the power provided by the vehicle's battery flows into the 12 VDC relay, power from the unit's lesser voltage batter is interrupted leaving the sound device dormant. When the ignition key is in the “off” position the vehicle ceases to provide the 12 VDC current into the relay which no longer interrupts the flow of current between the unit's lesser voltage battery and the sound device. Thus, when armed and the vehicle is on, the alert is dormant, when armed and the vehicle is off, the alert is active.

### CROSS REFERENCE TO RELATED APPLICATIONS

N/A

### COPYRIGHT STATEMENT

N/A

### FEDERAL RESEARCH STATEMENT

[N/A]

### APPENDIX DATA

N/A N/A N/A

### BACKGROUND OF INVENTION

It is my belief that my invention is best defined in “Class 340—Communications: Electric”. Subclassications “438—Internal alarm or indicator responsive to a condition in the vehicle” and “500—Condition responsive indicating system” seem the most appropriate sub classifications available.

Each year several infants and small children die of heat related illnesses after being left unattended in automobiles. The purpose of this invention is to provide an alert system that will address this problem.

### SUMMARY OF INVENTION

The “Baby in Car Alert” is designed to prevent the senseless death of infants and small children by alerting overtired or otherwise distracted caregivers that the child is in the car seat when the ignition key is in the “off” position. Hearing the alert will remind caregivers that they still have a matter (the child) to attend to prior to leaving the car.

Pressure switch activated the weight of the child when placed in the car seat turns the system on. The device is armed but dormant while the vehicle ignition key is in the “accessory” or “on” position. The device becomes active when the vehicle ignition is in the “off” position. Removing the child from the car seat turns the system off.

For convenience of the caregiver the pressure switch is plugged into the component box. This allows the caregiver to unplug the pressure switch wiring from the component box to temporarily turn the unit off or remove the car seat from the vehicle.

### BRIEF DESCRIPTION OF DRAWINGS

FIG. 1—Drawing and identification of electrical components required to manufacture and operate the “Baby in Car Alert” system. Indication of pre-existing equipment in automobile that the alert system relies upon.

FIG. 2—Drawing of “Baby in Car Alert” system and identification of illustrated parts.

FIG. 3—Exploded view of “Baby in Car Alert” system and its placement in relationship to the car seat base and pad.

### BRIEF DESCRIPTION OF SEQUENCES

N/A

### DETAILED DESCRIPTION

Manufacture and Usage of the System:

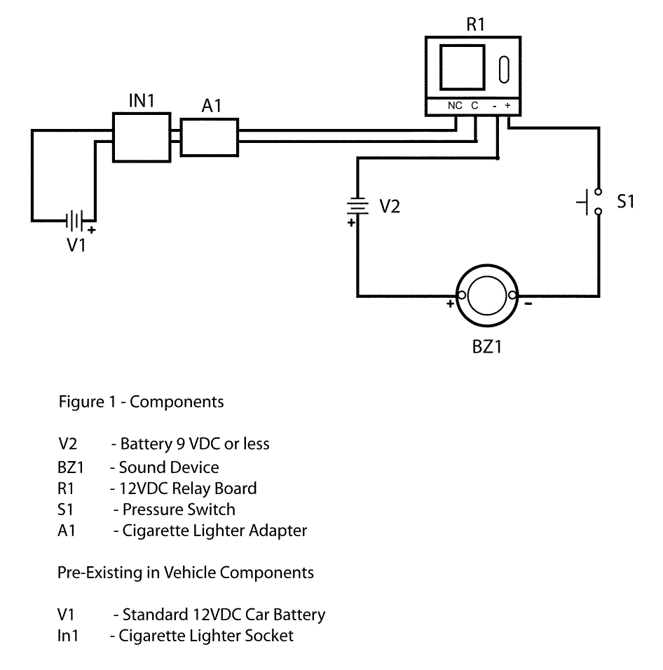

A lever style pressure switch (FIG. 1, S1) is utilized. The negative input is connected via wiring to a sound device/alert or buzzer (FIG. 1, BZ1). The positive side of the pressure switch (FIG. 1, S1) is wired into the 12 VDC Relay Board (FIG. 1, R1) NC input designation.

The positive connection of the sound device is wired into the positive side of the unit's battery (9 VDC or less) (FIG. 1, V2). The negative connection on the unit's battery (FIG. 1, V2) is wired into the 12 VDC Relay Board (FIG. 1, R1) C input designation.

The negative and positive wires of a standard Cigarette lighter adapter/DC plug adapter (FIG. 1, A1) are fed into their respective designations within the 12 VDC Relay Board (FIG. 1, R1).

The Cigarette lighter adapter (FIG. 1, A1) is plugged into the vehicle's pre-existing Cigarette lighter socket (FIG. 1, IN1). The vehicle's pre-existing 12 VDC Battery FIG. 1, V1) provides power to the Cigarette lighter socket.

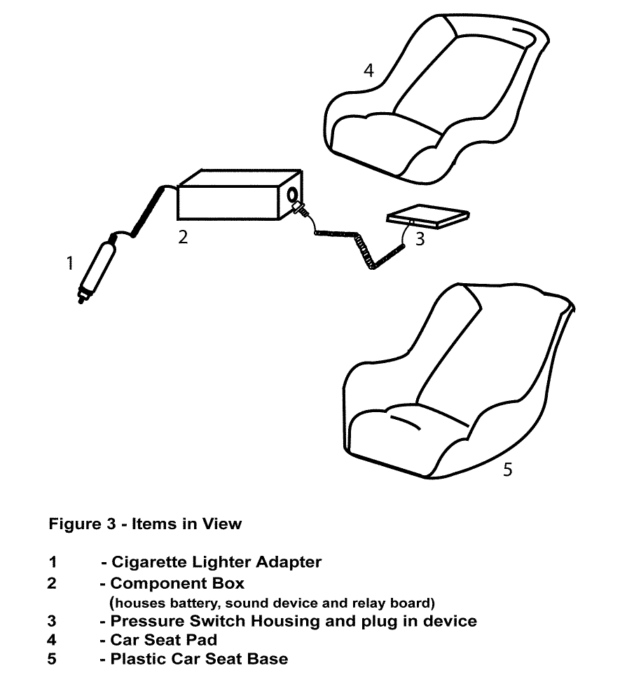

Once the electrical components have been assembled the pressure switch (FIG. 1, S1) is housed in a hermetically sealed plastic sleeve (FIG. 3, 3). Double sided tape allows the consumer to securely attach the pressure switch to the car seat base (FIG. 3, 5). The car seat pad (FIG. 3, 4) is then re-secured to the car seat base.

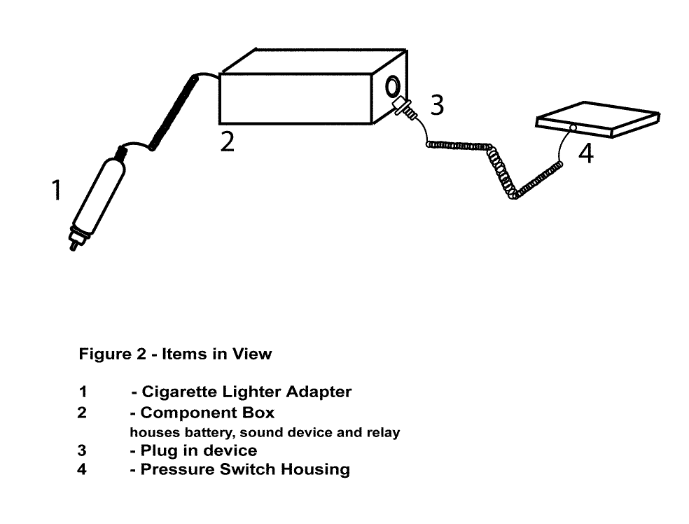

The component box (FIG. 2, 2) which houses the battery (FIG. 1, V2), the sound device (FIG. 1, BZ1) and the relay board (FIG. 1, R1) is placed within easy reach of the vehicle's driver, then plugged into the vehicle's pre-existing cigarette lighter socket (FIG. 1, IN1) and remains this way.

When the infant/child is placed into the car seat the pressure switch (FIG. 3, 3) is in the “on” position but lacks power. Upon starting the vehicle the caregiver inserts the pressure switch plug into the component box. The unit is now fully active but the sound device is dormant.

Once the vehicle ignition key is placed in the “off” position the relay switch (FIG. 1, R1) routes power from the unit's battery (FIG. 1, V2) to the sound device (FIG. 1, BZ1) making the sound device active. The sound emitted alerts the driver that the child is still in the car seat. Removing the child from the car seat turns the unit off, while unplugging the pressure switch (FIG. 2, 3) from the component box (FIG. 2, 2) disables the unit.

Program Listing Deposit

N/A

1. What I claim as my invention is a weight activated alarm device, turned on by a pressure switch the unit's alarm is dormant while the vehicle is turned on and becomes active when the vehicle is turned off.
